(19) United States
(12) Patent Application Publication
(10) Pub. No.: US 2001/0034846 A1
(43) Pub. Date: Oct. 25, 2001

(54) Digital data and software security protection

(76) Inventor: Peter Beery, Cedar Park, TX (US)

Correspondence Address: Steven W. Smith, c/o David Dingeman, 550 Trees Drive, Cedar Hill, TX, 75104, US

(21) Appl. No.: 09/795,222

(22) Filed: Feb. 28, 2001

Related U.S. Application Data
(60) Provisional application No. 60/185,453, filed on Feb. 28, 2000.

(51) Int. Cl. H04L 9/00; G06F 12/14; G06F 15/173

(52) U.S. Cl. 713/201; 709/226; 709/229

(57) ABSTRACT

The present invention provides for a system method of preserving digital intellectual property data and software security utilizing a network by removing a random chunk of data from executable code and only delivering the proper chunk, size and location upon successful authentication of the user, the computing device environment and previous registration history.

### BACKGROUND OF THE INVENTION

Software piracy, copyright infringement and software licensing breach are growing faster than any other industry because of fast growth of the Internet and the emergence of high-speed data transmission networks. Piracy of this type of intellectual property is even a greater problem in the digital environment because the user can remain anonymous and is unlikely to receive a subpoena from the infringed company due to the high costs of tracing the illegal distribution of software. An expert in software piracy estimates that over $15 billion a year is lost due to the unauthorized copying and use of software, music, books, and movies.

Smaller companies are especially devastated by software piracy because of high litigation costs, the popularity of their niche software and the lost revenue for each sale. One example of high-end audio software piracy and abuse can be seen at the usenet group: alt.binaries.sounds.utilities. Upon opening this usenet group, the visitor will find over 8900 requests and responses providing illegal audio utilities. One such request stated: “Request: Please post Guitar Pro 3 (full version with crack or code)”. Many responses were posted provided to this message and other requests supplying full, unlicensed and copyrighted audio software such as CDXtract, Cakewalk Pro Audio 9, Mobius, and BeatCreator.

With broadband connections becoming more standard and employees taking advantage of their employer's state-of-the-art networks, the amount of intellectual property that can be downloaded and the speed with which it can be transmitted will increase dramatically. In addition, other countries actively promote software piracy; Russia will not shut-down offending Internet Service Providers who allow pirated software to remain on their servers and the Chinese government promotes the state-run China.net which has links to web sites that provide free, pirated software.

The present invention provides a system and method for solving the software piracy problem by protecting digital intellectual property.

1. Technical Field

The present invention relates to providing a secure manner of distributing licensed software across a network. More particularly, to a method and system for providing secure software delivery over a network allowing for the successful installation and execution of licensed software on a personal computer, wireless device, web-enabled phone, or server.

2. Description of the Prior Art

The prior art solution to software piracy and copyright infringement have been to rely almost entirely on encryption methods which, if the encryption algorithm is broken, breaches the integrity of the data or application and allows the user fall use of the software. In the example from the usenet group alt.binaries.sounds.utilities; software is traded freely along with the encryption codes needed to crack and run the software. With over 8900 responses and requests for audio software alone on this one usenet group, it is evident that the prior art has not solved the problem of the illegal distribution of software to date.

Michael Scholnick, U.S. Pat. No. 5,978,918—Security Process for Public Networks, Nov. 2, 1999, provides a secure manner of transferring private information between nodes on a public network and allows for conducting of secure commerce over a public network. The commerce can be either the transmission and receipt of electronic data, such as software, or the processing of a payment.

The Scholnick patent replaces the notion of an encryption system with a method for replacing secure data with a time sensitive token which is encrypted. All data or proprietary software is stored on a private, back-end system which acts as a mailbox for private data. This private data can be retrieved by using the authorized token. An encrypted and authorized token may be intercepted by an unauthorized party, and decrypted thereby exposing the data. In addition, this method and system only hides sensitive data from unauthorized parties and does not protect proprietary software from unlicensed or illegal copyright use. In addition, when a private token or key is sent and validated; the data or software application can be used without limitations meaning that when the code or data is unlocked; the party can continue to use the data or software without any additional verification. In summary, this method and system of authentication only secures data against unauthorized use by 3^{rd} parties and does not protect against unlicensed use by primary party who are using the data in an illegal manner.

Jeffrey C. Smith, U.S. Pat. No. 6,061,448 Method and System for Dynamic Server Document Encryption, May 9, 2000, provides a method and system for secure document delivery over a wide area network utilizing a secret key to encrypt documents which are then encrypted using a public key. The encrypted document and key is transferred across a network exposing it to interception and decryption by unauthorized parties.

Smith only discloses a method and system for automatically and dynamically retrieving a public encryption key over a network using a server to retrieve the key. Smith, as Scholnick before him, only protects for the interception of software by unauthorized parties, however, the patent does not protect software applications from unlicensed use by primary parties, for example, where a user's license has exceeded the licensed time limit or the user is using the software on multiple computing devices.

FIG. 1 is a diagram illustrating software protection according to the prior art. Server 10 hosts data 20. This data is scrambled 22 with a public key. The resulting encrypted data 24 is sent to client's computer 12 and stored on the hard drive. A private key 32 is used to unscramble the data resulting in useable data 34. Useable data 34, now unlocked, may be used or transmitted to other user's for illegal, unlicensed use.

John S. Erickson, U.S. Pat. No. 5,765,152, Jun. 9, 1998, provides a system and method to manage copyrighted electronic media and a method for maintaining an electronic bibliographic record of successive data transfers of protected electronic media. This prior art also provides a system and method for packing and unpacking of electronic media within an electronic container to facilitate the management of copyrighted electronic media. Erickson defines “Document” as an electronic or digital file that is constructed according to the invention by packaging the electronic media into a secure document format to manage or otherwise enable the control, access, and /or licensing of the media.

The Erickson patent provides for the licensing of media to creators of derivative works by means of a viewer obtaining authorization by registering on a registration server and obtaining a license through an authorization server. All access and modifications to the “document” are recorded in an electronic bibliographic record maintained with the “document” or on authorization servers. This method of capturing an electronic bibliographic record for each use of copyrighted media can become overwhelmingly large and eventually, the media file itself will be dwarfed an unuseable by the associated bibliographic record.

The Erickson patent only protects media by recording access and derivation of a work; it does not request or grant authorization to use such work based on registration. Encryption is only used to enhance or guarantee the authenticity of the entire work including authorship; this method does not prevent software piracy.

### SUMMARY OF THE INVENTION

The problem of software piracy and copyright infringement is solved by the present invention which provides a system and method that prevents the illegal installation and subsequent use of digital intellectual data and software.

The present invention applies to all digital data and software. Digital data is any object, file, spreadsheet, document, embedded object or database file that is in an electronic format and stored on a computer type device. An embedded object is an object created with one application and embedded into a document created by another application; embedding the object, rather than simply inserting or pasting it, ensures that the object retains its original format. Computer type device is defined as personal computers, wireless devices, web-enabled phones, web television, computer servers and hand-held computers. While the present invention discloses the transfer of digital data or software across a broadband network in the preferred embodiment; those skilled in the art will see that all types of networks and data transfer are obvious.

Software is defined in the present invention in three general classes: digital data, system software and application software. System software consists of low-level programs that interact with the computer at a very basic level. This includes operating systems, compilers, and utilities for managing computer resources. Application software, also called end-user programs, includes database programs, word processors, and spreadsheets. Application software sits on top of system software because it is unable to run without the operating system and system utilities.

The present invention provides for a system and method of preserving the software security of digital data and software utilizing a network such as broadband. Network is defined as any computer type device linked to a server, where linked is defined as any connection between two or more devices; examples of such a connection include but are not limited to: telephone connection, broadband, digital cable, wireless data link, local area network, wide area network, optical network, intranet, internet, and any combination thereof.

The present invention prevents illegal software installation and use by providing a mechanism which requires registration of software, adding a software wrapper around the executable code and the removing of a portion of the software to prevent installation and use unless a valid registration is received. The present invention may utilize present encryption protocols available in the public domain or proprietary encryption methods including: secure socket layer protocol, electronic transaction protocol, digital encryption standard protocol, public key encryption protocol, and symmetric key encryption protocol.

In a preferred embodiment, all software use requires 100% registration whereby a user downloads software from a server by means of a network or purchases the software in any electronic media format and begins the installation process. The purchased software and directory structure is delivered in a compressed format using standard zip compression and encrypted utilizing any encryption protocol. The encryption method will vary with each distribution of the software. Any delivery of the software will be associated with a unique serial number which is recorded on the distributor's database. The delivered software is also wrapped by software programs which assist in registration, run-time authentication, run-time installation and post-execution clean-up. In addition, a non-contiguous data chunk is removed from the software prior to delivery and stored on the distributor's server along with the serial number and registration information. The non-contiguous data chunk is defined as a block of memory which, in the preferred embodiment, may range from 1 kilobyte to 1 megabyte in size. The non-contiguous data chunk is never stored with the software package including the temporary installation directory. The size and location of each data chunk removed from the software will vary from distribution to distribution to enhance security protection. The size and location of each removed chunk is stored on the distributor's database as an instance for each distribution along with the associated serial number, registration information, and the particular encryption method used in the particular instance.

In the registration process, all registration is handled prior to download and installation of the delivered software. A registration data tag is embedded into the software in several locations using several known methods to further enhance security. This tagging scheme serves as a watermark that uniquely identifies each licensed owner. The level of security is tunable based on the requirements of the software distributor and is more secure than the industry encryption standard developed by Philip Zimmerman, known as the Pretty Good Privacy (PGP) method. In one embodiment, the security level of the present invention was tuned to 10³⁰⁸ times more secure than the PGP standard.

In the preferred embodiment, the registration process collects information on the user such as name, address, and e-mail address; on the user's environment such as hardware characterization data, bios, and ethernet address; on the delivered product such as serial number, registration data tags, and the missing data chunk (size and location); in addition to a date/time stamp. This data is stored associatively on the distributor's server.

In the preferred embodiment, after the user has received the software which includes the wrapper programs and the software executable with the missing chunk of data, the user begins installation of the software on their computing device for the first time. The wrapper programs may or may not contain portions of non-executable content. The first wrapper program, H1, verifies that a clean install environment is present and no other programs are running on the computing device. If other programs are running, H1 informs the user with a list of these programs for the user to terminate. H1 can only execute if the user is connected to a network by broadband or other method. H1 passes user registration and machine characterization data to an authentication server. The process of authenticating includes the verification of the user submitting valid and complete registration information including machine characterization data which is submitted automatically by H1. The authentication process also includes the server checking for prior registrations and terms of the license agreement; if such information is found, the server compares the registrations for validity. If registration is authenticated; the user receives the missing chunk of code to proceed with installation of the software. If the registration is invalid, a license violation and or code crack will be assumed to exist. Invalid registrations will be found to exist if multiple copies of a single runtime license have been used on the client computing device; the machine characterization data does not match, or may be marked as invalid by distributor specified criteria. If a violation or code crack is detected the following actions are taken: First, the particular transformation used to secure the cracked software is moved to a retired transformation list. The retired transformation list is a database, table or file which tracks and stores all invalid software information to prevent invalid use. Second, the license associated with the cracked distribution instance of software is revoked. Third, all information on record about the user associated with the cracked software's license is passed to the Anti-Piracy Enforcement group or other software anti-piracy groups. Fourth, other users whose software uses the retired transformation will have a new transformation integrated into their system the next time they try to run the software. This process can be handled in the background without the user being aware of the transformation. Finally, the user will not be able to use the acquired software because the missing chunk has disabled use of the software.

For successful authentication, wrapper H1 proceeds with the installation of the software. A runtime flag is sent to the authentication server and stored with other user and machine information. The missing, runtime chunk is decrypted by the method stored in the software instance profile and the install program is executed. When the install program successfully completes, a second wrapper, H2, is run which is responsible for clean-up of the program directory, temporary installation directories, and system memory. H2 also sends a message back to the authentication server to update the instance profile and machine characterization data; this information is re-validated and the runtime flag is cleared as a successful and valid installation.

In the specific case of downloading software from a network, the download server uses a unique key passed to it to select the pre-encrypted and compressed software package which is then downloaded to the user's computing device assisted by H1. Once the download is complete, a flag value is incremented in the user profile stored on the authentication server. A time stamp for the download is also recorded on the server for future upgrades, patches, and re-installation.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 2 is a simple architecture environment of a computing device and a server connected to a network according to the present invention;

FIG. 3 is a hardware/software schematic illustrating the general method of operation for the present invention.

FIG. 4 is a schematic illustrating the general method of operation for the present invention.

FIG. 5 is a flowchart illustrating the method of operation of the present invention in the preferred embodiment.

FIG. 5a is a server schematic further describing the flowchart of FIG. 5.

FIG. 5b is a client use case schematic further describing the flowchart of FIG. 5 in the preferred embodiment.

FIG. 5c is a second client use case schematic further describing the flowchart of FIG. 5 in an alternative preferred embodiment.

### DETAILED DESCRIPTION OF EMBODIMENTS

The present invention provides for a system and method of preserving digital intellectual property data and software security utilizing a network by removing a random chunk of data from executable code and only delivering the proper data chunk, size and location upon successful authentication of the user, the computing device environment and previous registration history.

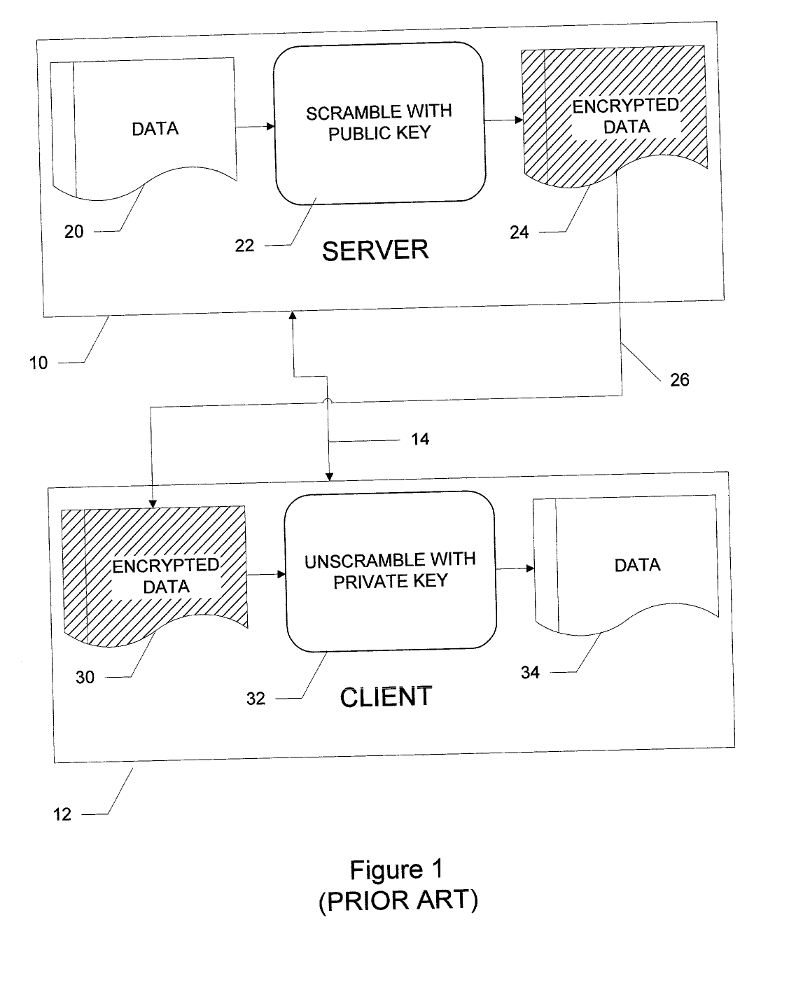

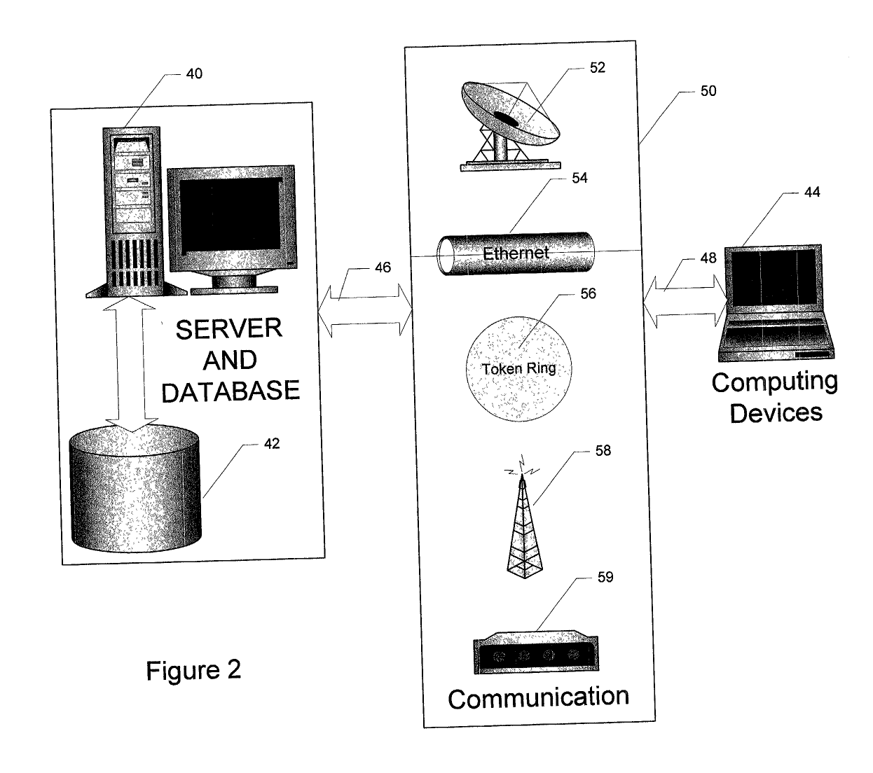

FIG. 2 is a simple, hardware architecture environment of the present invention. In FIG. 2, server 40 is depicted as a representation of any server that contains data or software for distribution. Server 40 may be a single server or a plurality of servers. In the preferred embodiment, server 40 represents an installation server, registration server, and authentication server used to verify user registration. Each server 40 is connected to a database 42 or a file storing device which maintains the data used in the present invention to register, authenticate, and install the digital data or software. Database 42 may reside on server 40 or reside on other servers, computers or other devices (not shown). Arrow 46 represents communication utilizing any communication means 50 to a network. Examples of network connectivity 50 include: satellite 52, ethernet 54, token ring 56, radio/microwave 58, modem 59, cable (not shown), telephone connection by modem 59, broadband (not shown), digital cable (not shown), wireless data link 52 and 58, local area network and wide area network 54 and 56, optical network (not shown), and any combination thereof. FIG. 2 also shows a user connecting 48 by the networking means 50 to a personal computing device 44. Personal computing devices 44 include personal computers, wireless devices, web-enabled phones, web television, computer servers, and hand-held computers.

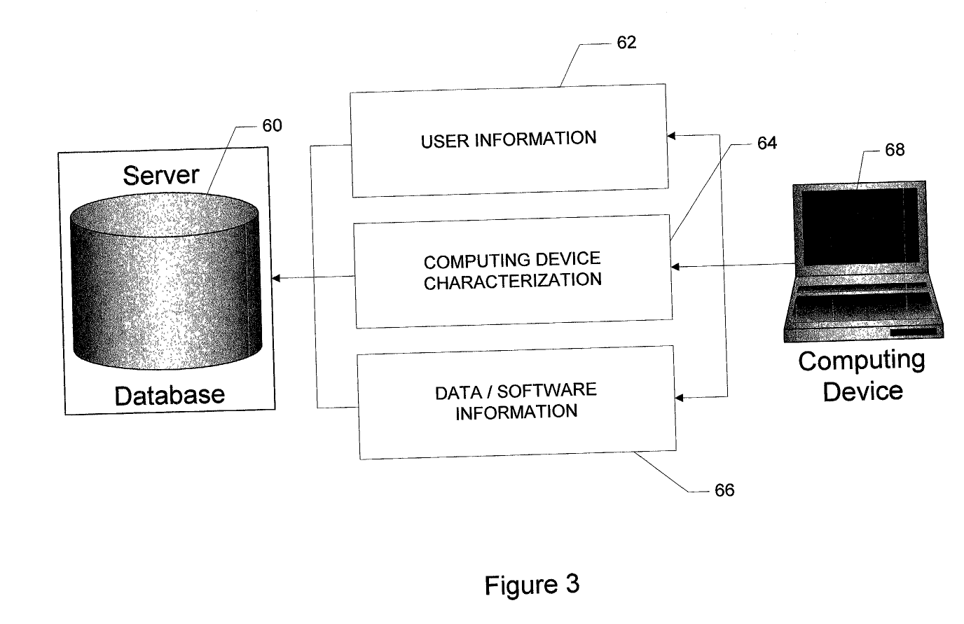

FIG. 3 is a hardware/software schematic of the present invention illustrating the registration step submitted by a user requesting data or software. The method and system of the present invention comprises of a database 60 which resides on a server or other computer which is connected to a network by means shown in FIG. 2. A user who desires to install and use digital data or software begins the installation on their personal computing device 68. To initiate an install of data or software, the user is prompted for specific information which is required by the authentication and registration server(s) and database(s) 60. Required information is determined by the distributor or licensor of the data or software the user desires to install or use. In the preferred embodiment, the user submits user information 62 which includes name, address, city, state, zip, country if outside the US, and e-mail address. A wrapper program (not shown) started by the user to initiate the request for data or software also sends computing device/machine characterization data 64 to database 60. User or the wrapper program also transmits data and software information 66 to database 60. Such information 66 includes serial number or registration number of the data or software requested. All information collected during this request is stored as an instance on database 60 associatively for future authentication and to enable data or software for the present session.

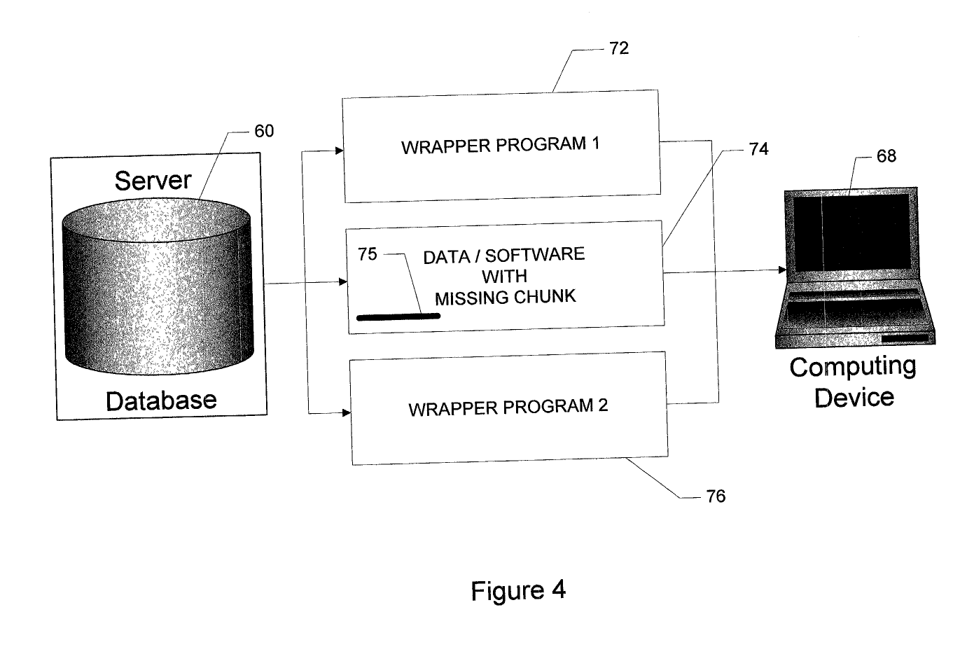

FIG. 4 is a hardware/software schematic of the present invention illustrating the authentication and data/software delivery steps delivered by a server to a user who has made a request for data or software. Database and server 60 receive the information 62, 64 and 66 (FIG. 3) and authenticates this information based on criteria specified by the distributor/licensor of the data or software. In the preferred embodiment, the server 60 searches for the serial number or registration number in the present request instance and matches that against instances already in the database. If another instance is found with a matching serial or registration number, the user information records 62 (FIG. 3) are compared and the computing device characterization data 64 (FIG. 3) is compared. If the information is valid based upon defined criteria, installation may proceed. FIG. 4 depicts how a user may acquire the secured data or software which is the subject of the present invention. The user, utilizing personal computing device 68 may obtain data or software 74 along with first wrapper program 72 and second wrapper program 74 by means of the Internet, World Wide Web or by acquiring data or software on CD-ROM or other electronic media. The acquired software and directory structure is delivered in a compressed format using standard zip compression and encrypted utilizing any encryption protocol. The encryption method will vary with each distribution of the software. In the embodiment of the present invention, all data or software found by using a network, downloaded, purchased, or acquired by other means is stored without the missing data chunk 75. Missing data chunk 75 impedes data or software 74 from installation and execution because a block of code is removed from the data or software. The missing data chunk 75 may be of any size or location in the executable code. In the preferred embodiment, the size of missing data chunk 75 ranges from one kilobyte to one megabyte. The size and location of missing data chunk 75 along with a time stamp and run-time flag are stored on server database 60 associatively for future authentication and use by the user.

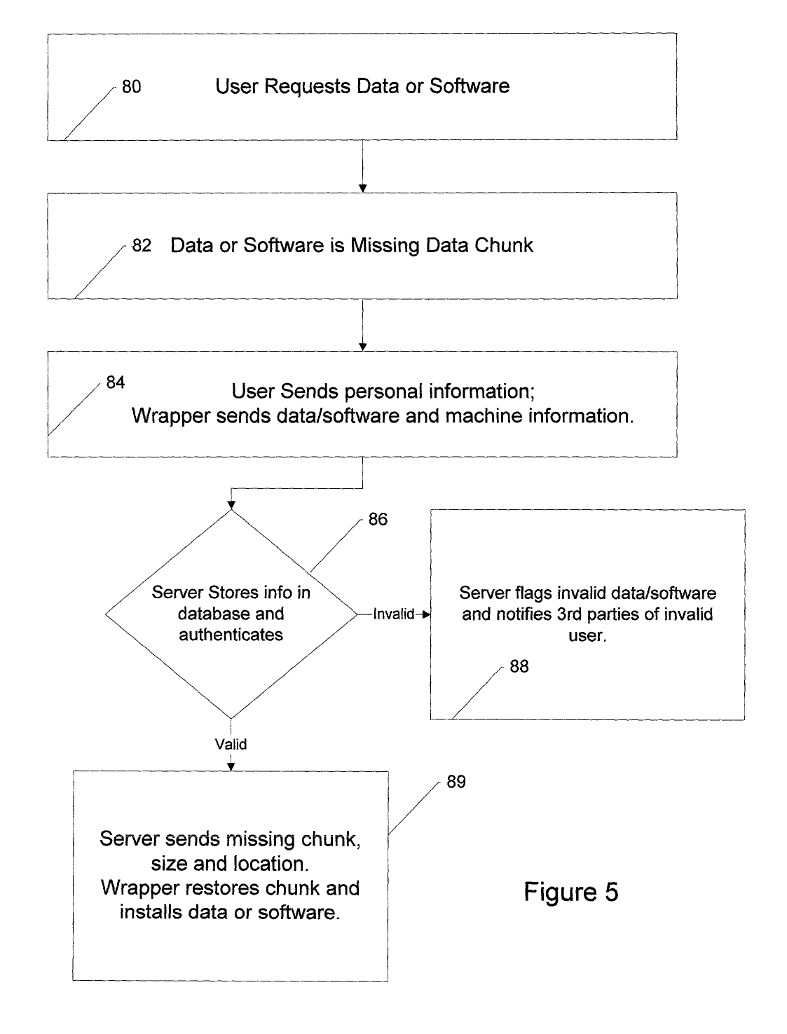

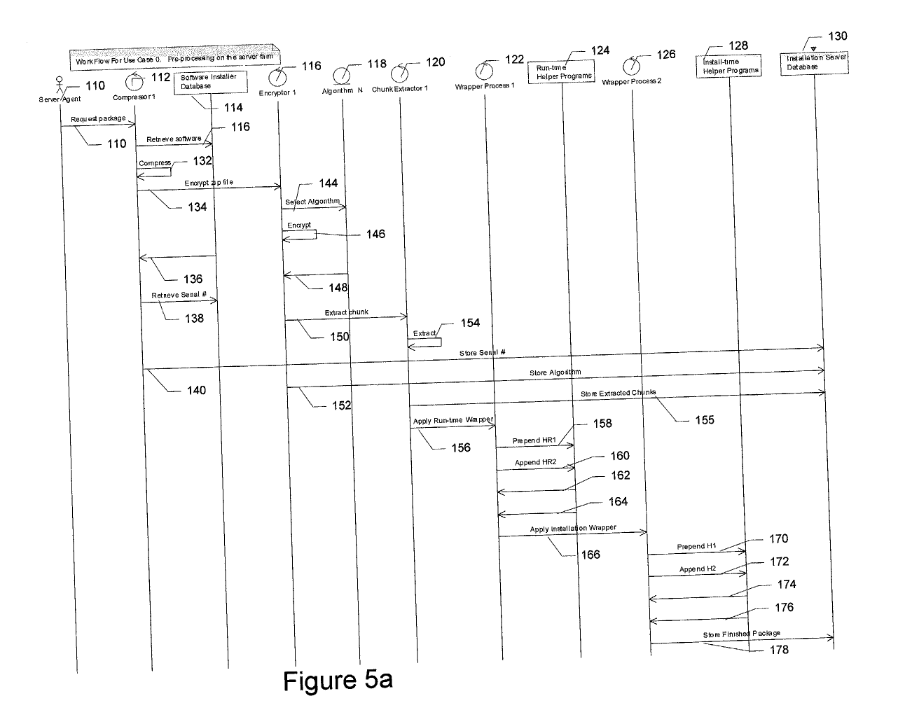

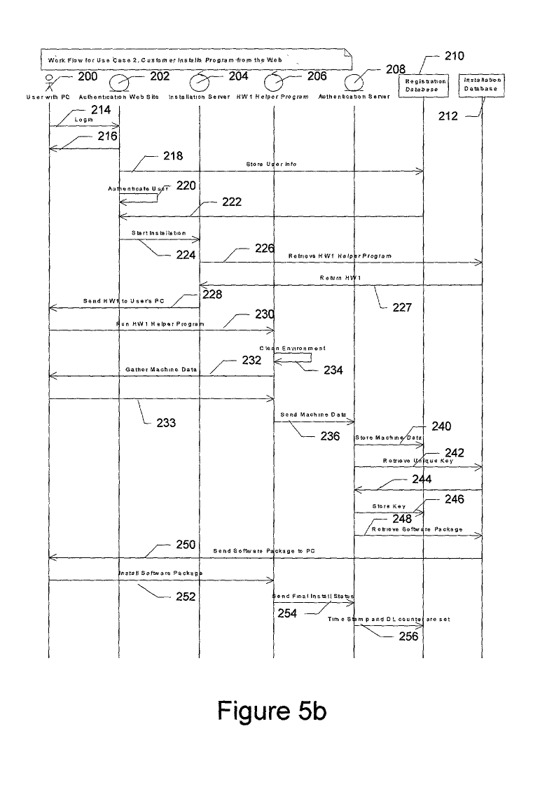

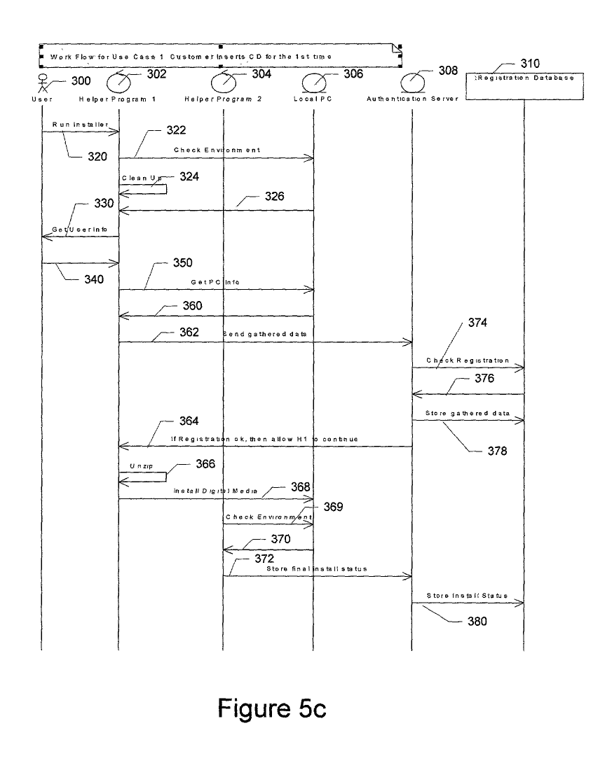

FIG. 5 is a flowchart depicting the secure delivery of digital data or software in the preferred embodiment. User requests data or software 80 from a server, from the Internet or acquires data or software in electronic media format. Data or software 82 is missing a key data chunk from the executable which makes the installation and execution of the software inoperable. User sends personal information and wrapper programs send data and software information 84 to the server. Server is defined as a single or plurality of servers which store information 84, process information, store data and software, register information, authenticate information, enable installation and communicate with client computing devices. Information 84 include personal information such as name, address, and e-mail address; data and software information such as registration and serial number; and machine information such as bios, operating system, and machine name. Server stores information in authentication database and authenticates 86 based on defined criteria and information in the registration database. If the information 84 is found to be invalid 88, then the server flags the invalid data or software and notifies 3^{rd} parties of the invalid occurrence possibly sending all information 84 to the appropriate parties. If the information 84 is found to be valid; the server sends 89 the missing chunk of data which is processed by wrapper programs allowing for the installation of the data or software. Server is also notified of successful completion of the data or software and updates associated run-time and installation flags.

FIG. 5a is a schematic of the logic and processing that occurs on the server(s) described in the flowchart of FIG. 5 when a request is made for data or software. The server farm shown in FIG 5a. includes server agent 110, first software compressor 112, software installer database 114, first encryptor 116, nth algorithm 118, first chunk extractor 120, first wrapper process 122, run-time helper programs 124, second wrapper process 126, install-time helper programs 128, and installation server database 130. When a request is made for data or software, server agent 110 sends data or software to first compressor 112. In the alternative, first compressor 112 may request data or software from server agent 110 First compressor 112 compresses 132 data or software in a standard compressed format. First compressor 112 also requests 136 a unique serial number from the software installer database 114 and retrieves 138 unique serial number from software installer database 114. First compressor 112 sends 140 unique serial number to installation server database 130. In addition, first compressor 112 sends 134 compressed file to first encryptor 116.

First encryptor 116 sends 144 a request to nth algorithm 118 for one of a plurality of encryption algorithm methods. nth algorithm 118 sends 148 encryption method to first encryptor 116. First encryptor 116 encrypts 146 the compressed file received from first compressor 112. First encryptor 116 sends algorithm method used to encrypt 146 to installation server database 130. First encryptor 116 sends encrypted file to first chunk extractor 120. First chunk extractor 120 receives compressed and encrypted file made up of data or software from first encryptor 116. First chunk extractor 120 extracts 154 a data chunk from file based on a plurality of methods which may vary the size of the chunk extracted and the location of the chunk extracted. In the preferred embodiment, the size of the chunk extracted may range from one kilobyte to one megabyte and the location will always vary. First chunk extractor 120 sends extracted chunk to installation server database 130. First chunk extractor 120 sends compressed, encrypted file missing the data chunk to first wrapper process 122.

First wrapper process 122 requests first run-time helper program 158 and second run-time helper program 160 from run-time helper programs library on server 124. Run-time program server 124 sends requested helper programs to first wrapper process 122. First wrapper process 122 prepends first run-time helper program 162 and appends second run-time helper program 164 to compressed, encrypted file missing data chunk received from first chunk extractor 120. Runtime wrapper is applied and run-time wrapper package is sent 166 to second wrapper process 126.

Second wrapper process 126 requests 170 first install-time helper program and requests 172 second install-time helper program from install-time helper programs library on server 128. Install-time program server 128 sends requested helper programs to second wrapper process 126. Second wrapper process 126 prepends first install-time helper program 174 and appends second install-time helper program 176 to compressed, encrypted file missing data chunk received from first wrapper process 122. Install-time wrapper is applied and installation wrapper package is sent 178 to installation server database 130.

Installation server database 130, in the preferred embodiment, stores data or software serial number; encryption algorithm method used in the present instance; extracted data chunk along with size and location of data chunk; and an installation package comprised of a plurality of run-time helper programs, a plurality of install-time helper programs, and compressed and encrypted data or software minus the data chunk; all of which are stored associatively on the appropriate database.

FIG. 5b is a client based schematic further describing the flowchart of FIG. 5 in the preferred embodiment of a user requesting data or software from a network over the Internet. The schematic of FIG. 5b shows the interaction of a user with the server farm described in FIG. 5a. The user interacts with computing device 200 to request data or software from a network or the Internet comprising of authentication web site 202, installation server 204, first hardware helper program 206, authentication server 208, registration database 210, and installation database 212. User with computing device 200 initiate login 214 with authentication web site 202 and user submits personal information along with a request for data or software. Authentication web site 202 sends 218 user information to registration database 210 Registration database 210 searches for previous user information instances by comparing any existing information with the information submitted in the present instance. Registration database sends 222 any similar information instances back to authentication web site 202. Authentication web site 202 authenticates 220 based on criteria input into authentication algorithm. Authentication web site 202 confirms 216 or denies 216 user login request. If user information is authenticated, the installation process 224 begins on installation server 204 to authenticate previous valid uses of data or software occurred on a valid computing device. Installation server 204 requests 226 appropriate first hardware helper program 206 as determined by installation server 204. The appropriate first hardware helper program 206 is returned 227 to the installation server 204. Installation server 204 sends first hardware helper program 206 to user's computing device 200. The first hardware helper program 206 is executed to gather computing device data 232. Computing device data 232 is received 233 by first hardware helper program 206 and sent 236 to authentication server 208. Computing device data 232 is forwarded 240 to registration database 210. Registration database server 210 queries database to find pre-existing user and machine data registrations. Matching previous registrations are compared against present user and computing device information; if authenticated by authentication server 208 the installation continues. If information cannot be authenticated by authentication server 208, a flag is set 256 in registration database. If information is authenticated, authentication server 208 requests 242 a unique key from installation database server 212. Key is sent 244 to authentication server 208 and stored 240 along with user and computing device information on registration database 210. In addition, if information is authenticated, authentication server 208 requests and retrieves data or software package discussed in FIG. 5a from installation database server 212. Software package is sent 250 to user's computing device 200. First hardware helper program 206 installs 252 data or software on user's computing device 200. After installation is complete, first hardware helper program 206 cleans the user's computing device install environment. First hardware helper program 206 sends 254 final install status to authentication server 208. Authentication server 208 sends 256 installation status along with time/date stamp with data or software use information to registration database 210.

FIG. 5c is a second client use case schematic further describing the flowchart of FIG. 5 in an alternative preferred embodiment where user has purchased or acquired data or software in electronic media format such as a CD-ROM. The schematic of FIG. 5c shows the interaction of a user with the server farm described in FIG. 5a. The user 300 interacts with computing device 306 to register the data or software on electronic media comprising of first helper program 302, second helper program 304, computing device 306, authentication server 308 and registration database. User 300 with computing device 306 initiates 320 installer program 320. First helper program 302 requests 330 user information which is sent 340 by any network communication method such as broadband. First helper program 322 verifies that no other applications are running and that the personal computing device 306 is clean. If other programs are running, first helper program sends a request for user to terminate other applications. First helper program 302 also gathers personal computing device 306 machine characterization data.

First helper program 302 also requests 350 computing device 306 machine data. Computing device 306 sends 360 required information back to first helper program 302. First helper program gathers all relevant computing device and user information and sends 362 the information to authentication server 308 for authentication. Authentication server 308 sends 374 information to registration database 310. Registration database 310 finds matching records based on predefined criteria and sends 376 information back to authentication server 308. Registration database 310 also stores 378 gathered information for future authentication and use.

If authentication server 308 determines that the user and computing device information is valid; the installation process returns 364 to first helper program 302. If authentication is invalid; a flag is set, the data instance marked and notification is sent to interested parties such as software distributor and anti-piracy groups. For valid registrations, first helper program 302 unzips or de-compresses 366 data or software. First helper program also begins the installation process on personal computing device 306. The second helper program 304 re-verifies 369 that the environment is still in a proper form. If environment is proper; second helper program 304 begins installation 370 of the software along with the missing chunk data, size and location and decryption algorithm. Upon completion of data or software on computing device 306, second helper program 304 sends 372 final install status to authentication database 308. Authentication server 308 sends 380 installation information to registration database 310 for future authentication.

Accordingly, the invention should only be limited by the claims included below.

We claim:

1. A method for the secure delivering of digital data and software comprising the steps of:
a user requesting data or software from a server or receives data or software in any electronic media form;
the data or software is missing a data chunk;
the user registering the data or software sends personal information to an authentication server;
wrapper program sends data or software information and computing device information to server;
the authentication server authenticates relevant information from user and wrapper program;
the authentication server sends missing data or software chunk, size and location to wrapper program;
wrapper program restores missing chunk to data or software;
wrapper program successfully installs the data or software;

2. The method of claim 1, further comprising of said data or software being compressed in a standard zip format.

3. The method of claim 1, further comprising of said data or software being encrypted by standard encryption technology.

4. The method of claim 1 further comprising of said missing chunk being removed from said data or software and being stored on an authentication database server along with size and location of missing chunk.

5. The method of claim 1 further comprising of first wrapper program which cleans and verifies user computing device environment.

6. The method of claim 1 further comprising of second wrapper program which cleans the post-install environment.

7. The method of claim 1 further comprising of a plurality of run-time installation programs.

8. The method of claim 1 further comprising of a plurality of install-time installation programs.

9. A method for packaging data or software comprising the steps of:
a plurality of wrapper programs;
a missing data chunk;
a plurality of run-time installation programs;
a plurality of install-time installation programs.

10. The method of claim 9, further comprising the steps of a plurality of wrapper programs, a plurality of run-time installation programs, and a plurality of install-time installation programs all of which are assisting in the secure installation of data or software.

11. The method of claim 9 for invalidating data or software use comprising the steps of:
a user sending invalid registration information;
a server flagging registration as invalid;
the server recording user and computing device information;
the server sending notification to third parties of invalid use of the data or software along with user registration information and machine characterization data.

12. A system for securing data or software by means of removing a chunk of data or software comprising of:
a user sending valid registration information and computing device information;
a server authenticating registration and device information;
the server sending missing data or software chunk to user from database instance on authenticating server also containing size and location of chunk.
